(19) United States
(12) Patent Application Publication
(10) Pub. No.: US 2005/0238195 A1
(43) Pub. Date: Oct. 27, 2005

(54) Separated wires moving control device on earphone set

(76) Inventor: Jose Wei, Hsin Tien City (TW)

Correspondence Address: Jose WEI, P.O. Box No. 6-57, Junghe, Taipei, 235, TW

(21) Appl. No.: 10/892,214

(22) Filed: Jul. 16, 2004

(30) Foreign Application Priority Data
Apr. 27, 2004 (TW) 093111736

(51) Int. Cl. F16H 48/26; H04R 25/00

(52) U.S. Cl. 381/384; 381/370

(57) ABSTRACT

The present invention relates to an improvement of a separated wire moving control device of earphone set including: two separated left and right wires connecting to a plug on an end and to left and right earphones/earphone microphones on a top; at least one slip element, with left and right holes formed thereon, to be penetrated by left and right wires, thereby enabling the slip element to move along wires; a neck noose formed below the slip element, to be worn on a neck to enable wires duly attaching on an individual.

### BACKGROUND OF THE INVENTION

(a) Field of the Invention

The present invention relates to an improvement of a separated wire moving control device of earphone set, and more particularly for applying to an earphone set with long, dual wires and dual earphones.

(b) Description of the Prior Art

Referring to FIG. 9. A conventional earphone set includes two separated signal wires S1, S2, with earphones E1 and E2 formed on an end and a plug A on the other. The plug A is to connect with a MP3 player or a computer or a CD player, therefore, long wires S1 and S2 are needed.

FIG. 10 shows another conventional earphone set adding an anti-slip sheath B to bind wires S1 and S2.

Defects of above conventional products, after long use, can be as follows,
(1) Signal wires S1 and S2 can be twisted if only ends of earphones E1 and E2, plugging in ears, as fixing ends, with no intermediate device to regulate;
(2) Signal wires S1 and S2 can not be duly adjusted for a desired length or fixed at a proper position.

### SUMMARY OF THE INVENTION

It is an objective of the present invention to enable wires forming a neck noose and attaching properly on an individual when being worn on the neck.

It is another objective of the present invention to enable wires to be quickly adjusted to a desired length.

It is yet another objective of the present invention to enable wires to be separated and quickly released when being pulled.

It is yet another objective of the present invention to enable wires being easy in manufacturing, low in processing cost, and capable of having commercials thereon.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of a slip element (or a lower slip element) of the present invention.

FIG. 2 shows a perspective view of the present invention with the lower slip element securing a sling.

FIG. 3 shows another perspective view of the slip element (or the lower slip element) of the present invention.

FIG. 4 shows a perspective exploded view of FIG. 3.

FIG. 5 shows a cross-sectional view of the present invention for the slip element (or the lower slip element) moving along signal wires.

FIG. 6 shows a perspective view of an application of the present invention.

FIG. 7 shows a perspective view of another application of the present invention.

FIG. 8 shows a perspective view of another application of the present invention.

FIG. 9 shows a perspective view of a conventional earphone set with separated wires.

FIG. 10 shows a perspective view of a conventional earphone set with separated wires and an anti-slip sheath.

### DETAILED DESCRIPTION OF THE PREFERRED EMBODIMENTS

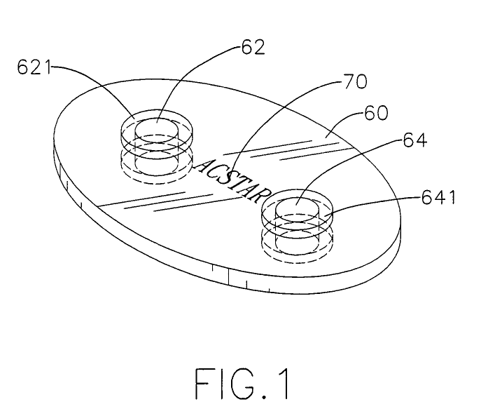

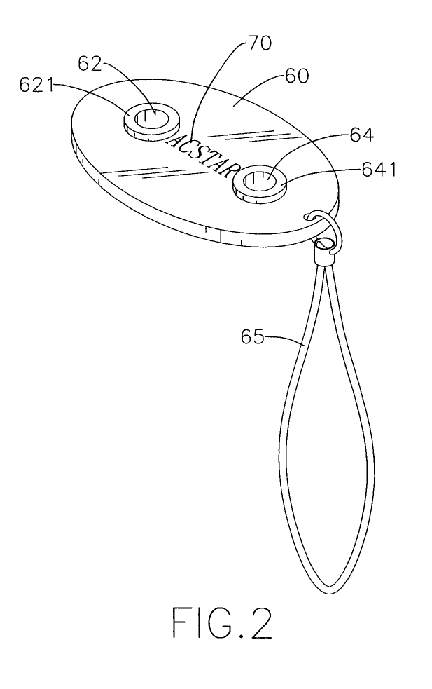

Referring to FIGS. 1, 2, 5 and 6. The present invention is an improvement of wire moving control device of earphone set including:
separated left and right wires 10 and 20 connecting to a plug 30 on an end and to left and right earphones 40 and 50 (or left and right earphone microphones) on a top;
at least a slip element 60, with left and right holes 62 and 64 formed thereon, to be penetrated by left and right wires 10 and 20, thereby forming a neck noose 15 underneath the slip element 60 and enabling the slip element 60 to move along left and right wires 10 and 20.

A device with major characteristics as recited above, wherein left and right holes 62′ and 64′ formed on a lower slip element 60′, to be penetrated by left and right wires 10 and 20 formed above the plug 30.

The device with major characteristics as recited above, wherein the neck noose 15 can be adjusted by a pull force to enable left and right wires 10 and 20 moving along holes 62, 64, 62′ and 64′.

The device with major characteristics as recited above, wherein elevated structures 621 and 641 formed on each perimeter of holes 62, 64, 62′ and 64′ to lengthen holes thereof.

The device with major characteristics as recited above, wherein a sling 65 is hooked on a lateral of the lower slip element 60′.

The device with minor characteristics as recited above, wherein commercials 70 can be formed on a surface of the slip element 60 or the lower slip element 60′.

The device with major characteristics as recited above, wherein a projection 631 engages with a groove 611 to form the slip element 60.

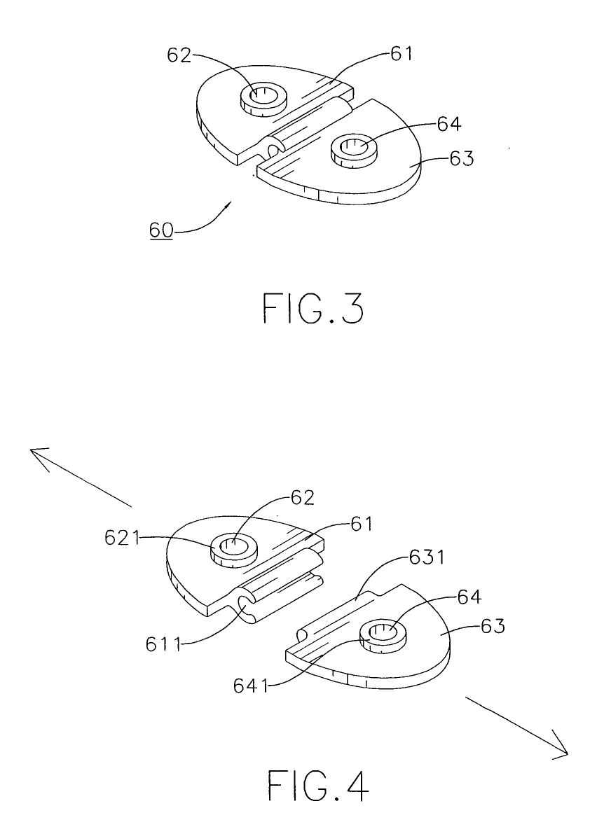

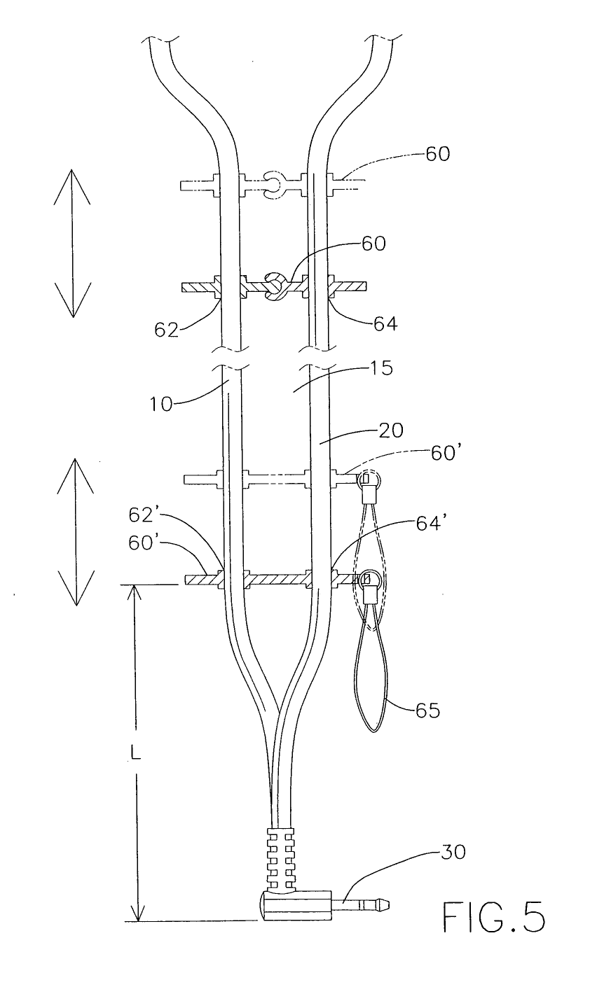

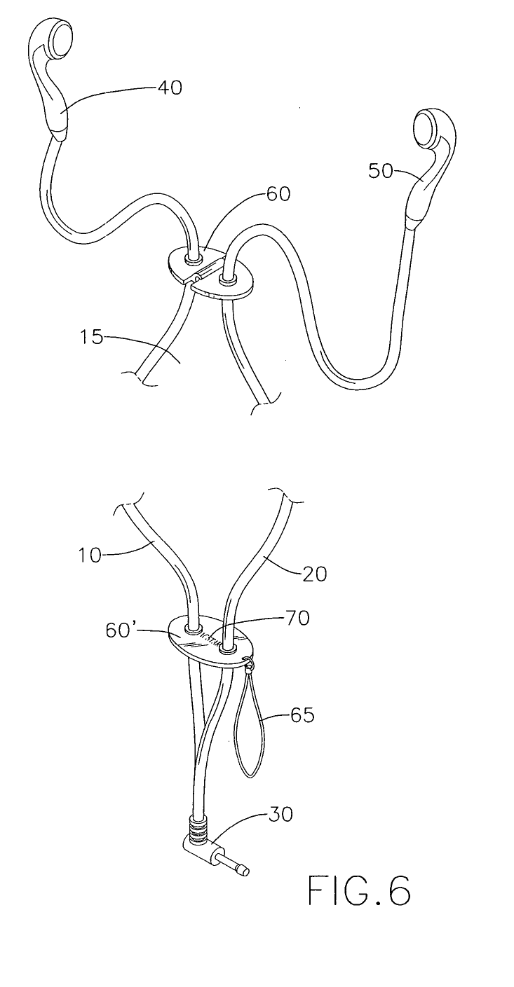

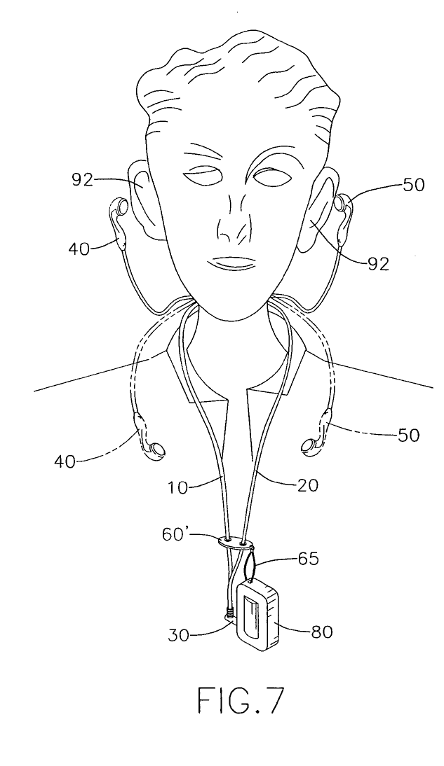

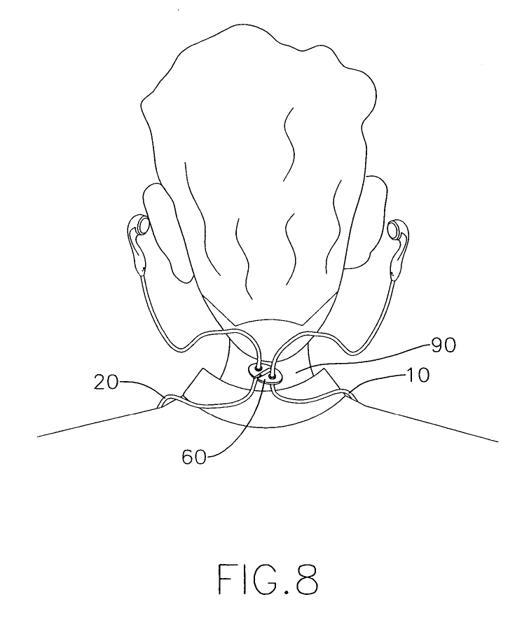

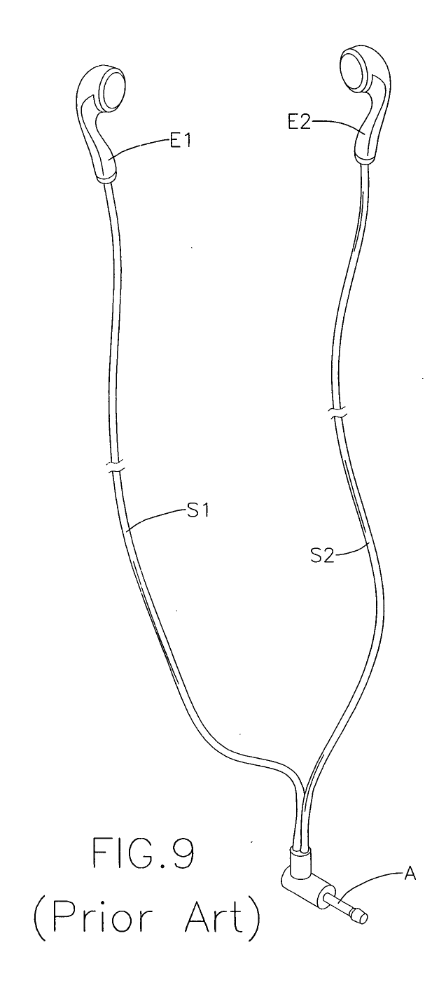

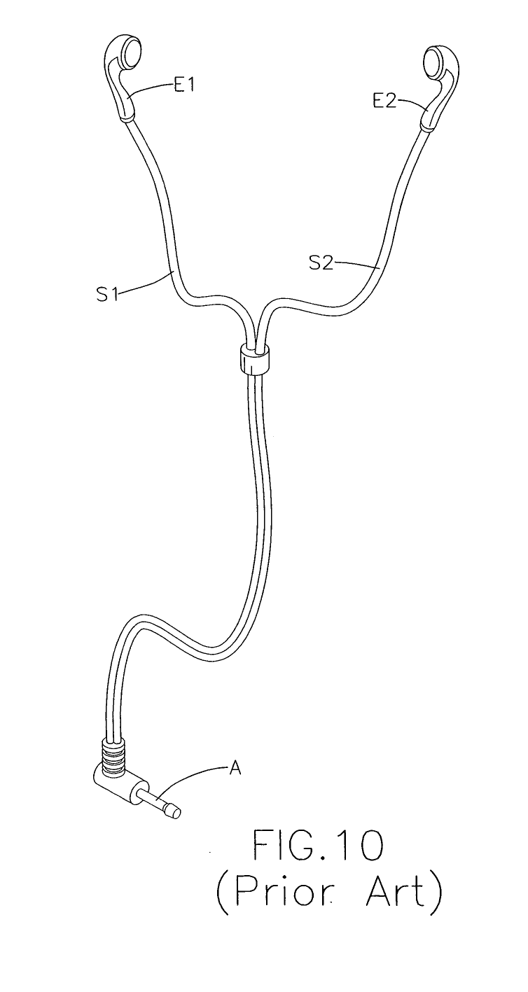

Applications and merits of the present invention are as follows,
1. Referring to FIGS. 5˜8. With the slip element 60 on a rear of a neck 90 when wearing the neck noose 15 and by moving the lower slip element 60′ along left and right wires 10 and 20, a distance L between the plug 30 and the lower slip element 60′ can be adjusted for plugging the plug 30 in a MP3 player 80 (or a computer or a CD player). Moreover, the sling 65 is also provided to hook up a MP3 player 80 (or a computer or a CD player). Referring further to FIG. 7. Earphones 40 and 50 (or earphone microphones) can be plugged in ears 92 to listen, or transmit voice signal when attaching a microphone at a proper location in the wire 10 or 20 (not shown in the FIG. 7).
2. Referring to FIGS. 3 and 4. The slip element 60 is formed by engaging a projection 631 with a groove 611, to be separated and quickly released when imposing a pull force upon wires 10 and 20, thereby an individual's head can be prevented from being pulled, which is dangerous, by a force from wires 10 and 20.
   Sizes of left and right holes 62 and 64 contacting with left and right wires 10 and 20 shall be just fit such that the slip element 60 and the lower slip element 60′ will not slip along left and right wires 10 and 20 when in static state. With a pull force imposing thereof, left and right wires 10 and 20 will move along holes 62 and 64 of the slip element 60 and along holes 62′ and 64′ of the lower slip element 60′, adjustments of the size of the neck noose 15 (as shown in FIG. 6) and the length L between the lower slip element 60′ and the plug 30 (as shown in FIG. 5) can then be made to facilitate a correct plugging of the plug 30 to a MP3 player (or a computer or a CD player).
   With the neck noose 15 formed by the slip element 60 and the lower slip element 60′ as upper and lower fixtures along left and right wires 10 and 20, twisting of separated left and right wires 10 and 20 thereby being avoided. With the neck noose 15 wearing on the neck, earphones 10 and 20 can be easily plugged in ears 92. With the adjustable characteristic, the neck noose 15 can fit for different neck sizes.
   With considerations of enhancing commercial effects, commercials or characters 70 can be formed on the slip element 60 or the lower slip element 60′.

The slip element 60 and the lower slip element 60′ can be in forms of a thin plate or a lump or a bar or any form that can perform functions hereinbefore.

In conclusion, the present invention utilize wires itself forming a neck noose, on the other hand, is able to replace prior products such as neck noose made of fabric requires to be attached to the wires.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A separated wire moving control device of earphone set comprising:
separated left and right wires connecting to a plug on an end and to left and right earphones/earphone microphones on a top;
at least one slip element having left and right holes formed thereon, being penetrated by left and right wires, thereby forming a neck noose underneath the slip element and enabling the slip element to move along left and right wires.

2. A separated wire moving control device of earphone set as recited in claim 1, wherein left and right holes formed on a lower slip element can be penetrated by left and right wires above the plug.

3. A separated wire moving control device of earphone set as recited in claim 1, wherein left and right wires can move, due to a pull force, along left and right holes of the slip element and the lower slip element to adjust the neck noose size.

4. A separated wire moving control device of earphone set as recited in claim 1, wherein elevated structures formed on each perimeter of left and right holes of the slip element and the lower slip element, thereby lengthen holes thereof.

5. A separated wire moving control device of earphone set as recited in claim 2, wherein a sling formed on a lateral of the lower slip element.

6. A separated wire moving control device of earphone set as recited in claim 1, wherein the slip element/the lower slip element can be in forms of a thin plate/a lump/a bar and advertisements can be formed thereon.

7. A separated wire moving control device of earphone set as recited in claim 1, wherein the slip element formed by engaging a projection with a groove.
